(19) United States
(12) Patent Application Publication
(10) Pub. No.: US 2008/0146141 A1
(43) Pub. Date: Jun. 19, 2008

(54) AIR SHOWER APPARATUS

(76) Inventors: Tomoru Murao, Niigata (JP); Youichi Yada, Murakami (JP); Taiki Yoshii, Niigata (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/830,001

(22) Filed: Jul. 30, 2007

(30) Foreign Application Priority Data
Dec. 13, 2006 (JP) 2006-336113

(51) Int. Cl. B01L 1/04

(52) U.S. Cl. 454/187; 15/415.1; 55/385.2

(57) ABSTRACT

In order to provide an air shower apparatus having good usability and high dust removing efficient, a nozzle for blowing out air is constructed to comprise a first body structure provided with a first air flowing path guiding air from a filter side to an air shower chamber side and with a second air flowing path in communication with the first air flowing path at mutually opposite positions on a side wall thereof, and a second body structure rotatably supporting the first body structure, wherein part of air sucked into the first air flowing path flows through the second air flowing path to cause a pressure difference between regions where the second air flowing path intersects with the first air flowing path and by change of the pressure difference with time, a flow direction of air flowing through the first air flowing path is varied with time.

### INCORPORATION BY REFERENCE

The present application claims priority from Japanese application JP2006-336113 filed on Dec. 13, 2006, the content of which is hereby incorporated by reference into this application.

### BACKGROUND OF THE INVENTION

(1) Field of the Invention

The present invention relates to an air shower apparatus which blows air into an air shower chamber and against a subject to be cleaned such as human body, outfits and otherwise products to remove dust attached to the subject and relates particularly to the construction of a nozzle for spurting air.

(2) Description of Related Art

Conventionally, an air shower apparatus is installed at the entrance and exit of a clean room, for example, to jet cleaned air at a high speed from nozzles, when a worker and products are passing, against the body of the worker, outfits, products and the like to thereby blow off and remove dust attached to them. A technology relating to the present invention and included in patent literature is seen in the publication of JP-A-2004-183964 for example. The JP-A-2004-183964 publication describes an air shower apparatus constructed to include nozzles in utilization of the Coanda effect so as to allow dust removal widely and highly efficiently. In the nozzle utilizing the Coanda effect, an air flow direction in an air blowout portion of the nozzle varies with time.

### BRIEF SUMMARY OF THE INVENTION

In the conventional air shower apparatus, the Coanda effect causes the air flow direction at the air blowout portion of the nozzle to vary and therefore, dust removal efficiency is higher and a range of air blowout is wider than those of a system having no change in the air flow direction. However, the air blowout portion of the nozzle is fixed, and it is deemed difficult to further increase the air blowout range. Further increase of the air blowout range may be possible by, for instance, additional installation of nozzles, which however will result in increase in the manufacturing cost.

In view of the above described circumstances of the related art, a task of the present invention is to further expand the air blowout range of each nozzle in an air shower apparatus with a nozzle having the Coanda effect.

An object of the invention is to provide an air shower apparatus having good usability and high dust-removing efficiency.

In order to attain the above task, according to the invention, an air shower apparatus has air blowout nozzles each of which comprises a first body structure provided with a first air flowing path, which guides air from a filter side to an air shower chamber side, and with a second air flowing path which is in communication with the first air flowing path at mutually opposite positions on a side wall thereof, and a second body structure rotatably supporting the first body structure, and each of which nozzles is constructed to let part of air sucked in the first air flowing path flow into the second air flowing path to cause a pressure difference in a region where the second air flowing path intersect with the first air flowing path and to vary a flow direction of air flowing through the first air flowing path with time through time change of the pressure difference.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 shows views of a construction example of an air shower apparatus as an embodiment of the present invention;

FIG. 2 is a view of a construction example of a nozzle used in the air shower apparatus of FIG. 1;

FIG. 3 shows explanatory views of air flowing paths in the nozzle of FIG. 2;

FIG. 4 is a view exemplifying the arrangement of nozzles in the air shower apparatus of FIG. 1;

FIG. 5 is a view of another construction example of a nozzle in the air shower apparatus;

FIG. 6 is a view of still another construction example of a nozzle;

FIG. 7 shows views of another construction example of air flowing paths in a first body structure of a nozzle;

FIG. 8 is a view showing still another construction example of air flowing paths in a first body structure of a nozzle; and

FIG. 9 is a view exemplifying another arrangement of nozzles in the air shower apparatus.

### DETAILED DESCRIPTION OF THE INVENTION

The embodiments of the invention will be now described with reference to the drawings.

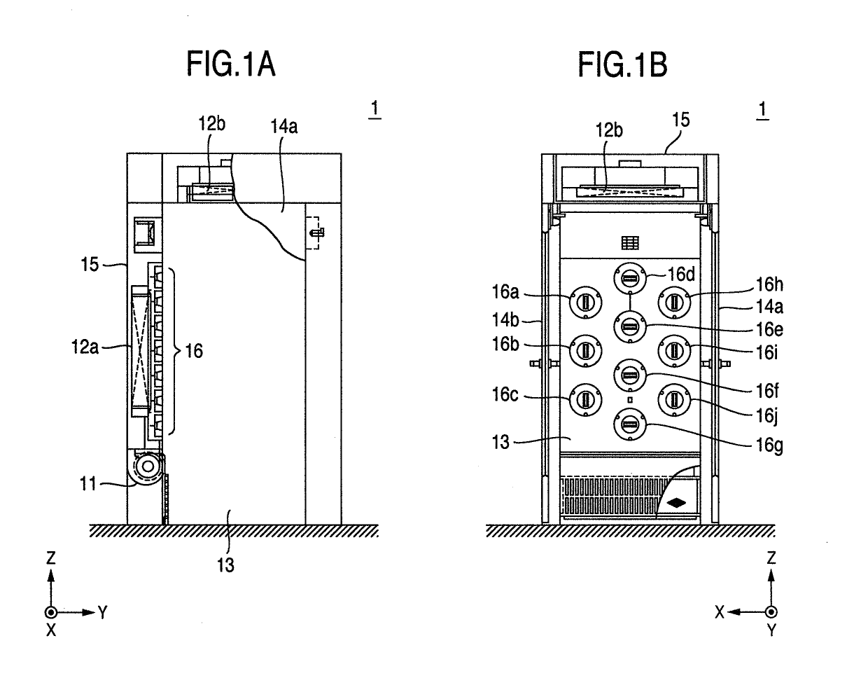

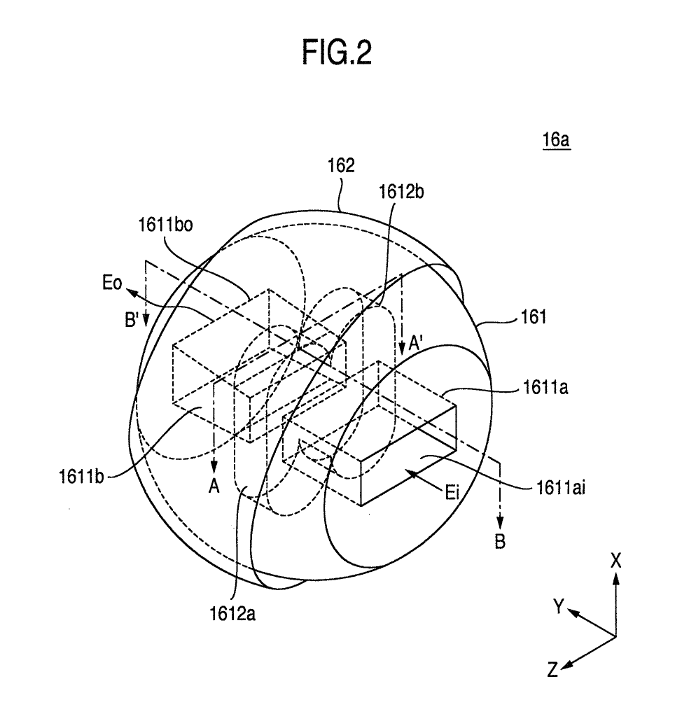

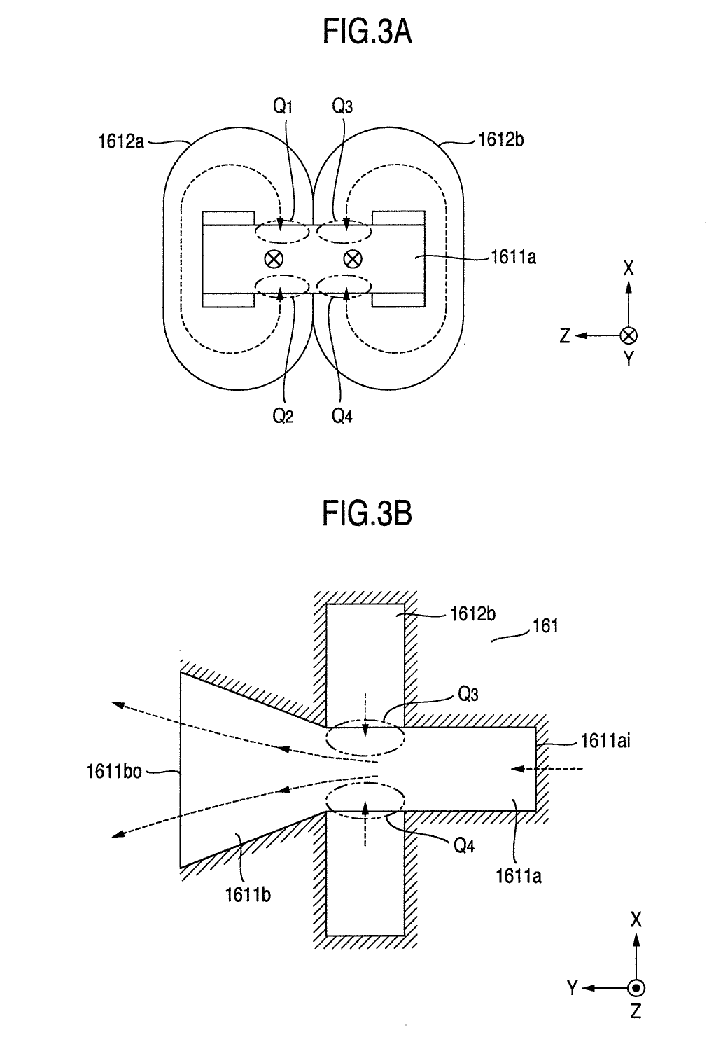

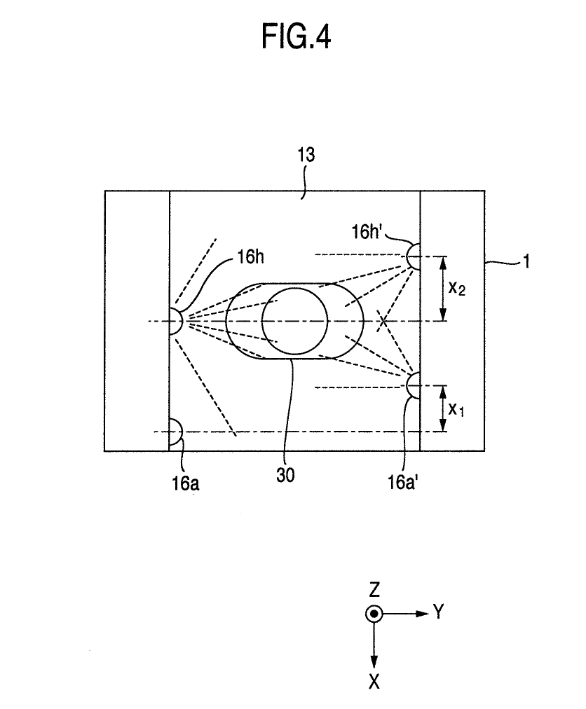

FIG. 1 to FIG. 4 are explanatory views of the air shower apparatus as the embodiment of the invention. FIG. 1 shows the views of the construction example of the air shower apparatus as the embodiment of the invention, FIG. 2 is the view of the construction example of the nozzle used in the air shower apparatus of FIG. 1, FIG. 3 shows the explanatory views of the air flowing paths in the nozzle of FIG. 2 and FIG. 4 is the view exemplifying the arrangement of the nozzle in the air shower apparatus of FIG. 1.

In the following, reference signs of component elements and coordinate axes to be used in the drawings will be common through all the drawings.

In FIG. 1, reference numeral 1 denotes the air shower apparatus blowing air into an air shower chamber against a subject such as a human body, outfits and products to be cleaned for removing dust attached thereto, reference numeral 11 a blower compressing and blowing air, reference numerals 12a and 12b filters filtering air from the blower 11, reference numeral 13 the air shower chamber, reference numerals 14a and 14b doors, reference numeral 15 an enclosure, and reference numerals 16 and 16a to 16g respectively denote the nozzles spurting the air from the filters 12a and 12b into the above described air shower chamber 13.

As for the above described nozzles 16, each of the nozzles 16a, 16b, 16c . . . 16g comprises a first body structure with the air flowing paths formed therein and a second body structure rotatably supporting the first body structure. The first body structure has a construction provided with, as air flowing paths, first air flowing paths which guide compressed air from a filter 12a, 12b side to an air shower chamber 13 side, and second air flowing paths which are in communication with the first air flowing paths at mutually opposite positions on a side wall thereof.

FIG. 1 illustrates only the nozzles 16a to 16g arranged on the left side (−Y axis direction) of the air shower 13 as the nozzles 16. However, nozzles have to be arranged on the right side (Y axis direction) of the air shower chamber 13 as well.

FIG. 2 is the view of the construction example of the nozzle 16a among the nozzles 16.

In FIG. 2, reference numeral 161 denotes the first body structure with the air flowing paths formed inside, reference numeral 162 the second body structure rotatably supporting the first body structure 161, reference numerals 1611a and 1611b the first air flowing paths which guide compressed air from the filter 12a, 12b side to the air shower chamber 13 side, reference numerals 1612a and 1612b the second air flowing paths which are in communication with the first air flowing paths at the mutually opposite positions on the side wall thereof, reference numeral 1611ai an air intake port of the first air flowing path 1611a, reference numeral 1611bo an air blowout port of the first air flowing path 1611b, reference sign Ei inflow air, and reference sign Eo blowout air. In the first body structure 161, the second air flowing paths 1612 cause the air flow direction in the first air flowing paths 1611a and 1611b to vary with time by the Coanda effect. More specifically, part of air that has flown into the first air flowing path 1611a flows through the second air flowing paths 1612a and 1612b and thereby generates a pressure difference between regions where the second air flowing paths 1612a and 1612b intersect with the first air flowing path 1611a. This pressure difference causes the air flow direction in the first air flowing paths 1611a and 1611b to vary with time so that airflow oscillation occurs inside the first air flowing paths 1611a and 1611b.

The first body structure 161 has a convex curve or convex sphere on its surface, and the second body structure 162 has a concave curve or concave sphere on its surface. The first body structure 161 is constructed to be three-dimensionally rotatable with respect to the second body structure 162 with its convex spherical surface directly or indirectly supported by the concave spherical surface of the second body structure 162, and is rotatable at least in an XY plane where the direction of air flowing through the first air flowing paths 1611a and 1611b varies, and in a YZ plane perpendicular to the XY plane. The other nozzles 16b to 16g are constructed likewise the nozzle 16a.

FIG. 3 shows the explanatory views of the air flowing paths in the first body structure 161 of the nozzle 16a in FIG. 2. FIG. 3A is an A-A′ section of the construction in FIG. 2 and FIG. 3B is a B-B′ section of the construction in FIG. 2.

In FIG. 3, reference signs Q₁ and Q₂ respectively denote regions where the second air flowing path 1612a intersects with the first air flowing path 1611a, and reference signs Q₃ and Q₄ respectively denote regions where the second air flowing path 1612b intersects with the first air flowing path 1611a. With this construction, when air flows therein, the Coanda effect takes place.

When the compressed air from the filter 12a, 12b side flows through the air intake port 1611ai into the first air flowing path 1611a in the first body structure 161 of the nozzle 16a, part of the air enters the second air flowing paths 1612a and 1612b and creates vortexes in the regions Q₁, Q₂, Q₃ and Q₄ respectively to make pressure differences between the regions Q₁ and Q₂ and between the regions Q₃ and Q₄. The pressure differences cause the flow direction of air flowing in the first air flowing paths 1611a and 1611b to vary with time. For example, in the case where pressure of the region Q₁ is lower than that of the region Q₂ and pressure of the region Q₃ is lower than that of the region Q₄ at a point of time, the air flow in the first air flowing path 1611a is drawn to the side of the regions Q₁ and Q₃. In such a flowing state, as time passes, the pressure in the regions Q₁ and Q₃ gradually increases, and that in the regions Q₂ and Q₄ gradually decreases. In conjunction with the increase of the pressure in the regions Q₁ and Q₃ and with the decrease of the pressure in the regions Q₂ and Q₄, the air flow in the first air flowing path 1611a gradually separates from the side of the regions Q₁ and Q₃ and, finally at some point of time, when the pressure of the region Q₂ becomes lower than that of the region Q₁ and the pressure of the region Q₄ becomes lower than that of the region Q₃, the air flow in the first air flowing path 1611a is drawn to the side of the regions Q₂ and Q₄. Thus, the second air flowing paths 1612a and 1612b draw the air flow in the first air flowing path 1611a to the side of the regions Q₁ and Q₃ or to the side of the regions Q₂ and Q₄ to oscillate the air flow in the XY plane (the Coanda effect). The air flow in the first air flowing path 1611b also varies in its direction (flowing direction) according to the air flow in the first air flowing path 1611a, and comes into an oscillating state.

FIG. 4 is the view exemplifying the arrangement of the nozzles in the air shower apparatus of FIG. 1.

In FIG. 4, reference numerals 16a′ and 16h′ denote the nozzles which are arranged on the right side (in the Y axis direction) of the air shower chamber 13 in FIG. 1 and are staggered from the nozzles 16a and 16h by predetermined distances x1 and x2 in the −X axis direction, and reference numeral 30 denotes a person (worker) to be cleaned in order to work inside a clean room, for example. Likewise the nozzles 16a and 16h, the nozzles 16a′ and 16h′ have first and second air flowing paths of the construction described in the above with reference to FIG. 2 and FIG. 3 in the first body structures, and the first body structures are rotatably supported by the second body structures. Further, although not illustrated in FIG. 4, nozzles 16b′-16g′, 16i′ and 16j′ are arranged on the right side (in the Y axis direction) of the air shower chamber 13 while being staggered from the nozzles 16b to 16g, 16i and 16j by predetermined distances in the −X axis direction. Alternatively, the nozzles on the left side of the air shower chamber 13 and those on the right side may be arranged at positions staggered from each other in the Z axis direction.

According to the air shower apparatus 1 of the construction described as above with reference to FIG. 1 to FIG. 4, in each of the nozzles 16a to 16j and 16a′ to 16j′, the first body structure 161 causes the flow direction of air flowing inside the first air flowing paths 1611a and 1611b to be changed with time by the second air flowing path 1612 so as to generate airflow oscillation inside the first air flowing paths 1611a and 1611b. This makes it possible to blow out air from the filter 12a, 12b side to a wide range of area in the air shower chamber 13. Further, by rotating the first body structure 161 three-dimensionally with respect to the second body structure 162, the direction of blowing our air whose flow direction varies may be changed at every nozzle, and the region where the blowout air reaches inside the air shower chamber 13 can be further expanded. Consequently, dust and the like attached to the body and outfits of the person 30 can be blown off and removed effectively. In addition, the number of nozzles can be decreased, and therefore, cost reduction can be attained.

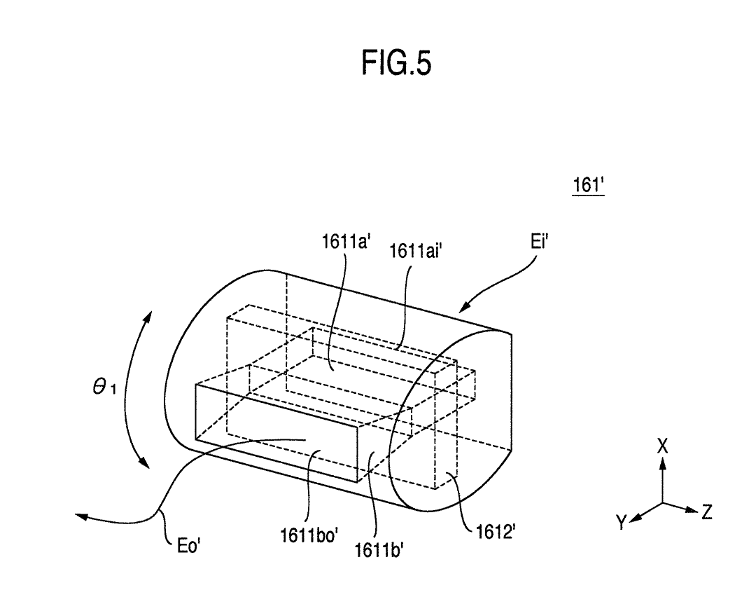

FIG. 5 is the view illustrating another construction example of a nozzle. This example is the case where a first body structure of the nozzle is constructed rotatably to a second body structure within a plane where the flow direction of air flowing through first air flowing paths varies.

In FIG. 5, reference numeral 161′ denotes the first body structure of the nozzle, reference numerals 1611a′ and 1611b′ the first air flowing paths which guide compressed air from a filter side to an air shower chamber side, reference numeral 1612′ a second air flowing path which is in communication with the first air flowing paths at mutually opposite positions on a side wall thereof, reference numeral 1611ai′ an air intake port of the first air flowing path 1611a′, reference numeral 1611bo′ an air spouting port of the first air flowing path 1611b′, reference sign Ei′ inflow air, and reference sign Eo′ blowout air. In the first body structure 161′, the second air flowing path 1612′ causes the air flow direction in the first air flowing paths 1611a′ and 1611b′ to vary by the Coanda effect. More specifically, part of the air that has flown into the first air flowing path 1611a′ flows through the second air flowing paths 1612′ and makes a pressure difference between two portions where the second air flowing path 1612′ intersects with the first air flowing path 1611a′. This pressure difference causes the flow direction of air flowing in the first air flowing paths 1611a′ and 1611b′ to vary with time to generate airflow oscillation inside the first air flowing paths 1611a′ and 1611b′. Consequently, the blowout air Eo′ whose flow direction varies with time is spurted from the air blowout port 1611bo′. The first body structure 161′ of the nozzle is rotated within an angular range θ₁ around the second body structure (not illustrated in the drawing) in the XY plane where the flow direction of air flowing inside the first air flowing paths 1611a′ and 1611b′ varies.

Also in the air shower apparatus using the first body structure 161′ of FIG. 5 as the first body structure of the nozzle, it is possible to further expand the region where the air sent from the air blowout port within the plane, in which the flow direction of air flowing inside the first air flowing paths 1611a′ and 1611b′ varies, reaches inside the air shower chamber. The reachable region inside the air shower chamber may be changed at every one of the nozzles. Consequently, dust and the like attached to a subject to be cleaned such as a human body, outfits and products can be blown off effectively.

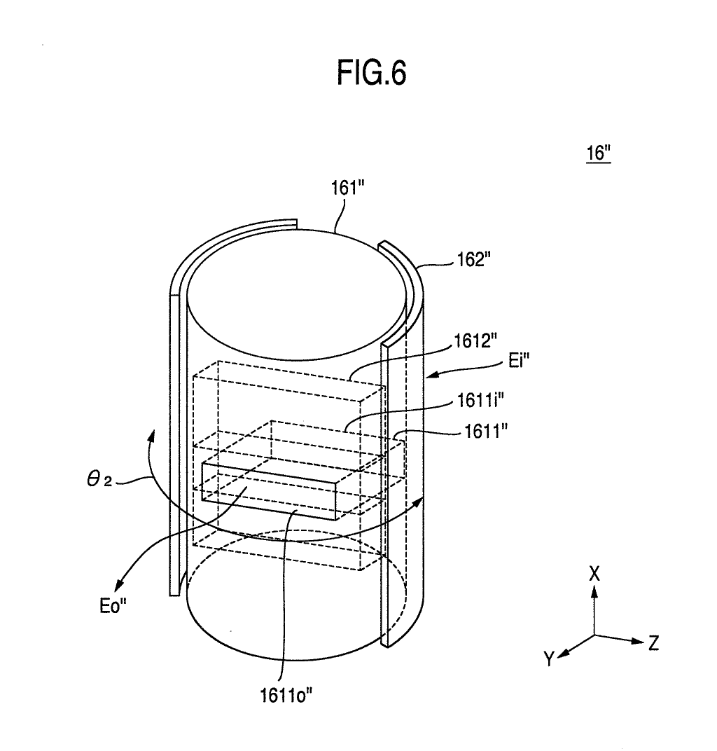

FIG. 6 is the view illustrating another construction example of a nozzle. This example is the case where a first body structure of the nozzle is constructed rotatably with respect to a second body structure in a plane perpendicular to a plane where the flow direction of air flowing through a first air flowing path varies.

In FIG. 6, reference numeral 16″ denotes the nozzle, reference numeral 161″ the first body structure of the nozzle 16″, reference numeral 162″ the second body structure of the nozzle 16″, reference numeral 1611″ the first air flowing path which guides compressed air from a filter side to an air shower chamber side, reference numeral 1612″ a second air flowing path which is in communication with the first air flowing path 1611″ at mutually opposite positions on a side wall thereof, reference numeral 1611i″ an air intake port of the first air flowing path 1611″, reference numeral 1611o″ an air blowout port of the first air flowing path 1611″, reference sign Ei″ inflow air, and reference sign Eo″ blowout air. In the first body structure 161″, the air flowing in the first air flowing path 1611″ is changed in its flow direction within the X-Y plane by the second air flowing path 1612″ and has airflow oscillation. The first body structure 161″ is rotated within an angular range θ₂ with respect to the second body structure 162″ in the YZ plane perpendicular to the XY plane in which the flow direction of air flowing in the first air flowing path 1611″ is varied.

Also in the air shower apparatus using the nozzle 16″ of FIG. 6 described in the above as a nozzle, it is possible to further expand the region where the air sent from the air blowout port in the plane perpendicular to the plane, in which the flow direction of air flowing through the first air flowing path 1611a″ is varied, reaches inside the air shower chamber. The reachable region inside the air shower chamber may be changed at every nozzle. Consequently, dust and the like attached to a subject to be cleaned can be blown off effectively.

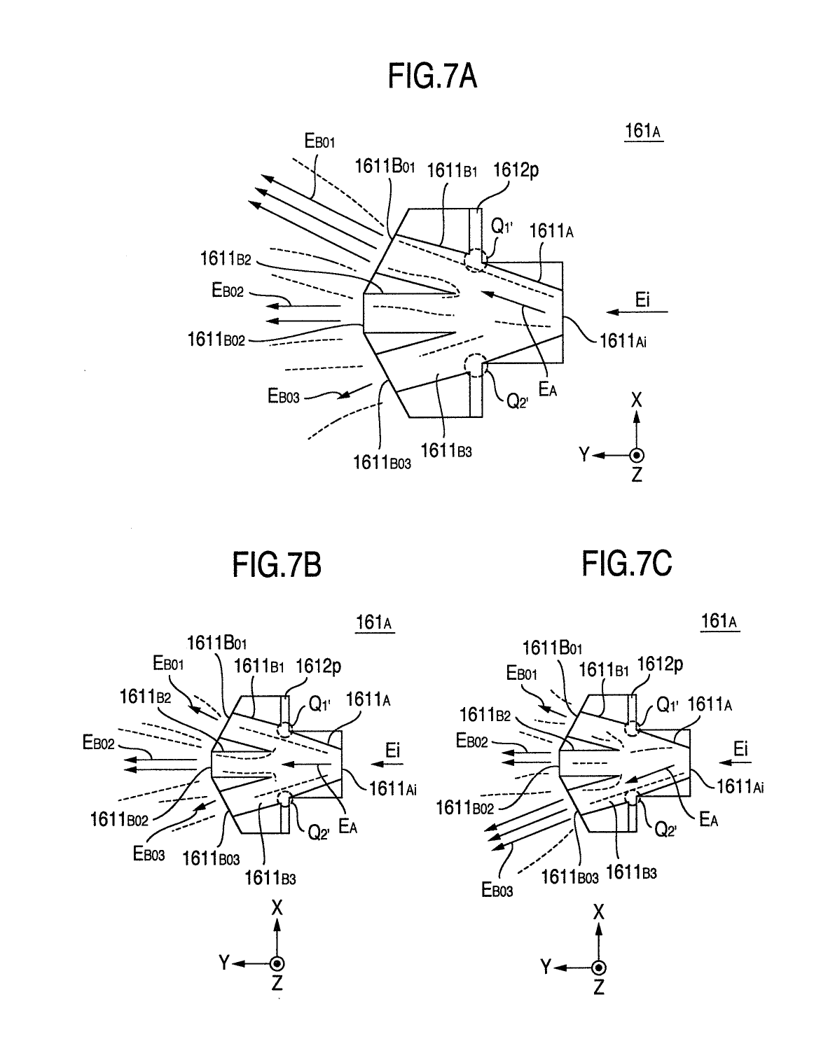

FIG. 7 shows the views of another construction example of air flowing paths in a first body structure of a nozzle. This example has the construction wherein, in the first body structure of the nozzle, a first air flowing path is divided into a plurality of flowing paths. FIGS. 7A, 7B and 7C illustrate a state where the flow direction of air flowing in the first air flowing path varies with time in the XY plane.

In FIG. 7, reference numeral 161_{A} denotes the first body structure of the nozzle, reference numeral 1611_{A} the first air flowing path which guides the air sent from a filter side, reference numerals 1611_{B1}, 1611_{B2} and 1611_{B3} the plurality of flowing paths (first air flowing paths) branched from the first air flowing path 1611_{A}, reference numeral 1612_{P} a second air flowing path 1611_{A} which is in communication with the first air flowing path at mutually opposite positions on a side wall thereof, reference numeral 1611_{Ai} an air intake port, reference numerals 1611_{Bo1}, 1611_{Bo2} and 1611_{Bo3} respectively denote air blowout ports of the first air flowing paths 1611_{B1}, 1611_{B2} and 1611_{B3}, reference sign Ei inflow air, reference numeral E_{A} flowing air in the first air flowing path 1611_{A}, and reference signs E_{Bo1}, E_{Bo2} and E_{Bo3} respectively denote blowout air from the air blowout ports 1611_{Bo1}, 1611_{Bo2} and 1611_{Bo3}.

In FIG. 7, inside the first body structure 161_{A}, the second air flowing path 1612_{P} causes the flow direction of air flowing in the first air flowing path 1611_{A} to vary in at least the XY plane by the Coanda effect. More specifically, part of the air that has flown into the first air flowing path 1611_{A} flows through the second air flowing path 1612_{P} and varies the respective pressure states in a Q₁′ portion and a Q₂′ portion where the second air flowing path 1612_{P} intersects with the first air flowing path 1611_{A}. FIG. 7A illustrates an air flowing state in the first body structure 161_{A} when a pressure difference is caused between the Q₁′ portion and the Q₂′ portion, namely in the case where pressure of the Q₁′ portion becomes lower than that of the Q₂′ portion. In that case, the air flow in the first air flowing path 1611_{A} is drawn in the X axis direction by the pressure difference and comes in the state of the flowing air E_{A}. Consequently, as for the first air flowing paths 1611_{B1}, 1611_{B2} and 1611_{B3} which are the branched air flowing paths, the first air flowing path 1611_{B1} has intake air of the largest flow rate, the flow rate of intake air to the first air flowing path 1611_{B2} is the next largest, and the flow rate of intake air to the first air flowing path 1611_{B3} is the smallest. The blowout air E_{Bo1} of the largest flow rate is spurted from the first air flowing path 1611_{B1}, the first air flowing path 1611_{B2} sends the blowout air E_{Bo2} of the next largest flow rate, and the first air flowing path 1611_{B3} sends the blowout air E_{Bo3} of the smallest flow rate.

Thereafter, as time lapses, the state of air flowing in the second air flowing path 1612_{P} changes, and the pressure difference between the Q₁′ portion and the Q₂′ portion is reduced. As the pressure difference decreases, the flow of air flowing in the first air flowing path 1611_{A} is drawn back in the −X axis direction. FIG. 7B illustrates an air flowing state in the first body structure 161_{A} in the case where the pressure difference between the Q₁′ portion and the Q₂′ portion becomes almost zero. In the state at that time illustrated in FIG. 7B, the branched first air flowing path 1611_{B2} has intake air of the largest flow rate, and the flow rates of intake air to the first air flowing paths 1611_{B1} and 1611_{B3} become almost equal. The blowout air E_{Bo2} of the largest flow rate is spurted from the first air flowing path 1611_{B2}, and the first air flowing path 1611_{B1} and 1611_{B3} send blowout air E_{Bo1} and E_{Bo3} of the almost equal flow rates.

Moreover, after that, as time lapses, the state of air flowing in the second air flowing path 1612_{P} changes further, and the pressure difference between the Q₁′ portion and the Q₂′ portion is increased so that the pressure of the Q₁′ portion becomes higher than that of the Q₂′ portion, that is, the pressure of the Q₂′ portion is lower than that of the Q₁′ portion. Because of the lower pressure of the Q₂′ portion than the Q₁′ portion, the flow of air flowing inside the first air flowing path 1611_{A} is further pulled back in the −X axis direction and comes in the flowing state shown in FIG. 7C. In the state of FIG. 7C, the first air flowing path 1611_{B3} sends the blowout air E_{Bo1} of the largest flow rate, the flow rate of the blowout air E_{Bo2} from the first air flowing path 1611_{B2} is the next largest, and the first air flowing path 1611_{B1} sends the blowout air E_{Bo3} of the smallest flow rate.

As described above, the flowing states of air in the first air flowing paths 1611_{A}, 1611_{B1}, 1611_{B2} and 1611_{B3} of the first body structure 161A of the nozzle shown in FIG. 7 changes in the order of FIG. 7A, FIG. 7B and FIG. 7C as time lapses. The first body structure 161A is supported by second body structure (not illustrated in the drawing) so as to be rotatable in a plane where the flow direction of air flowing inside the first air flowing path is varied or in a plane perpendicular to the former plane.

Also in the air shower apparatus using the first body structure 161_{A} of FIG. 7 in the nozzle, it is possible to further expand the region where the air sent from the air blowout port in the XY plane, in which the flow direction of air flowing through the first air flowing paths 1611_{A}, 1611_{B1}, 1611_{B2} and 1611_{B3} varies, reaches inside the air shower chamber. Further, the reachable region inside the air shower chamber can be varied at every nozzle. Consequently, dust and the like attached to a subject to be cleaned can be blown off effectively.

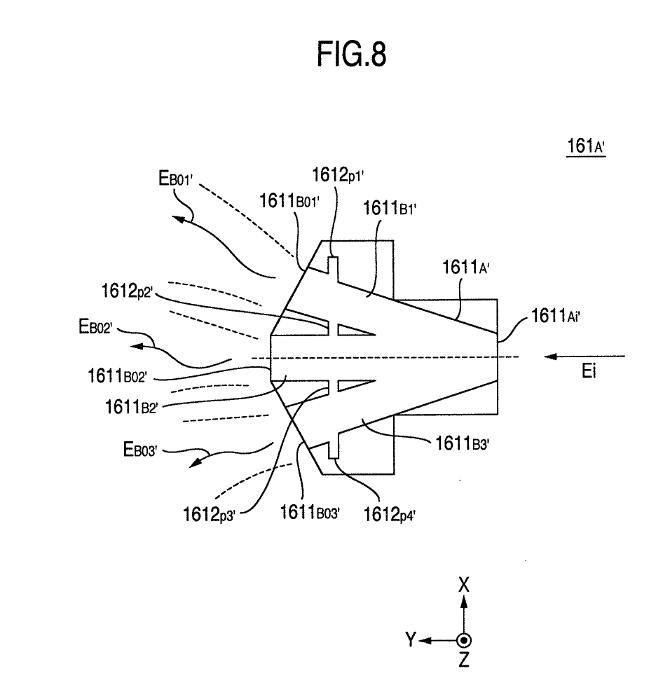

FIG. 8 is the view showing still another construction example of air flowing paths in a first body structure of a nozzle. This example is the case where, in the first body structure of the nozzle, the first air flowing path is divided into the plurality of flowing paths and second air flowing paths are provided on the plurality of branched flowing paths.

In FIG. 8, reference numeral 161_{A}′ denotes the first body structure of the nozzle, reference numeral 1611_{A}′ the first air flowing path which guides air taken from a filter side, reference numerals 1611_{B1}′, 1611_{B2}′ and 1611_{B3}′ the plurality of flowing paths (first air flowing paths) branched from the first air flowing path 1611_{A}′, reference numerals 1612_{P1}′, 1612_{P2}′ and 1612_{P3}′ the second air flowing paths which are in communication with the first air flowing path 1611_{B1}′ 1611_{B2}′ and 1611_{b3}′ at mutually opposite positions on side walls thereof, reference numeral 1611_{Ai}′ an air intake port, reference numerals 1611_{Bo1}′, 1611_{Bo2}′ and 1611_{Bo3}′ respectively denote air blowout ports of the first air flowing paths 1611_{B1}′, 1611_{B2}′ and 1611_{B3}′, reference sign Ei inflow air, and reference signs E_{Bo1}′, E_{Bo2}′ and E_{Bo3}′ respectively denote blowout air from the air blowout ports 1611_{Bo1}′, 1611_{Bo2}′ and 1611_{Bo3}′.

In FIG. 8, inside the first body structure 161_{A}′, the second air flowing paths 1612_{P1}′, 1612_{P2}′ and 1612_{P3}′ cause the air flow direction in the first air flowing paths 1611_{B1}′, 1611_{B2}′ and 1611_{B3}′ to be varied in at least the XY plane by the Coanda effect. More specifically, part of the air that has flown into the first air flowing paths 1611_{B1}′, 1611_{B2}′, 1611_{B3}′ flows through the second air flowing paths 1612_{P1}′, 1612_{P2}′, 1612_{P3}′ and changes the pressure states in the regions where the second air flowing paths 1612_{P1}′, 1612_{P2}′, 1612_{P3}′ respectively intersect with the first air flowing paths 1611_{B1}′, 1611_{B2}′, 1611_{B3}′. Due to the changes of the pressure states, in each of the first air flowing paths 1611_{B1}′, 1611_{B2}′, 1611_{B3}′, the flow direction of flowing air is varied in the XY plane.

As described above, in each of the first air flowing paths 1611_{B1}′, 1611_{B2}′, 1611_{B3}′ of the first body structure 161_{A}′ of the nozzle in FIG. 8, the state of air flowing changes as time lapses. The first body structure 161_{A}′ is supported by second body structure (not illustrated) so as to be rotatable in the plane where the flow direction of air flowing in the first air flowing paths changes.

Also in the air shower apparatus using the first body structure 161_{A}′ of FIG. 8 in the nozzle, it is possible to further expand the region where the air sent from the air blowout port in the XY plane, in which the flow direction of air flowing through the first air flowing paths 1611_{B1}′, 1611_{B2}′ and 1611_{B3}′ varies, reaches inside the air shower chamber. Further, the reachable region inside the air shower chamber may be varied at every nozzle. Consequently, dust and the like attached to a subject to be cleaned can be blown off effectively.

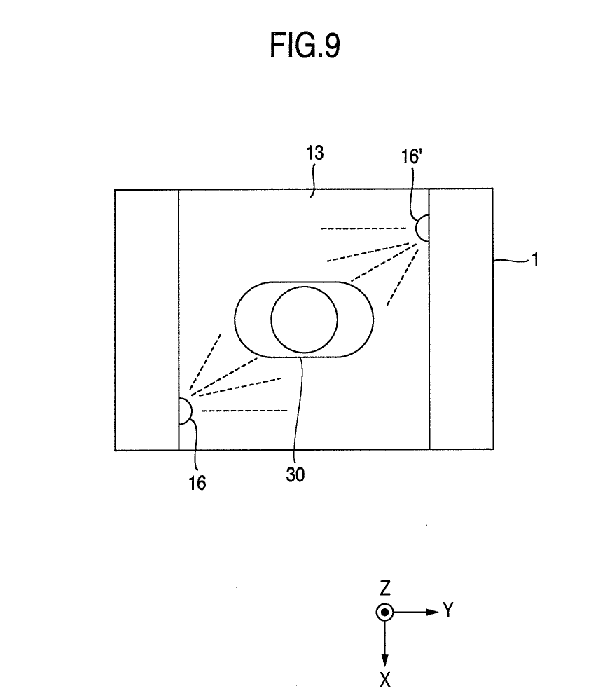

FIG. 9 is the view exemplifying another arrangement of nozzles in an air shower apparatus. Two nozzles 16a and 16a′ may be respectively disposed at a position near the entrance side of an air shower chamber and at a position near of the exit side of the air shower chamber to have a predetermined dust removing effect.

According to the present invention, is capable of further expanding the air blowout range of the nozzle in the air shower apparatus can be further expanded and it is possible to improve dust removing efficiency and usability.

It should be further understood by those skilled in the art that although the foregoing description has been made on embodiments of the invention, the invention is not limited thereto and various changes and modifications may be made without departing from the spirit of the invention and the scope of the appended claims.

1. An air shower apparatus for blowing out air in an air shower chamber against a subject to be cleaned and removing dust, comprising:
an air blower compressing and sending air;
a filter filtering air from the air blower; and
a nozzle blowing out air from a filter side in the air shower chamber, said nozzle comprising: a first body structure provided therein with a first air flowing path guiding air from the filter side to an air shower chamber side and a second air flowing path in communication with the first air flowing path at mutually opposite positions on a side wall thereof; and a second body structure rotatably supporting the first body structure,
wherein, said nozzle being constructed in a manner that in the first body structure, part of air sucked into the first air flowing path flows through the second air flowing path to cause a pressure difference between regions where the second air flowing path intersects with the first air flowing path and by the pressure difference, a flow direction of air flowing through the first air flowing path is varied with time.

2. The air shower apparatus according to claim 1, wherein said nozzle is constructed so that the first air flowing path of the first body structure is divided into a plurality of flowing paths.

3. The air shower apparatus according to claim 1 or claim 2, wherein said nozzle is constructed so that the first body structure has a convex curve on a surface thereof, the second body structure has a concave curve on a surface thereof, and the first body structure is three-dimensionally rotatable with respect to the second body structure with the convex curve supported on a concave curve side of the second body structure.

4. The air shower apparatus according to claim 1 or claim 2, wherein said nozzle is constructed so that the first body structure has a convex curve on a surface thereof, the second body structure has a concave curve on a surface thereof, the convex curve is supported on a concave curve side, and the first body structure is rotatable with respect to the second body structure in a plane where the flow direction of air flowing through the first air flowing path varies or in a plane perpendicular to the former plane.

5. The air shower apparatus according to claim 1 or claim 2, wherein said nozzles are provided in opposite inner wall portions of an inner wall forming the air shower chamber and at positions mutually staggered from opposite positions.
